(19) United States
(12) Patent Application Publication
(10) Pub. No.: US 2017/0303182 A1
(43) Pub. Date: Oct. 19, 2017

(54) USER APPARATUS, AND UPLINK TRANSMISSION SWITCHING METHOD

(71) Applicant: NTT DOCOMO, INC., Tokyo (JP)

(72) Inventors: Tooru Uchino, Tokyo (JP); Hideaki Takahashi, Tokyo (JP); Kazuki Takeda, Tokyo (JP); Sadayuki Abeta, Tokyo (JP)

(73) Assignee: NTT DOCOMO, INC., Tokyo (JP)

(21) Appl. No.: 15/513,008

(22) PCT Filed: Feb. 17, 2016
(86) PCT No.: PCT/JP2016/054581

§ 371 Date: Mar. 21, 2017

(30) Foreign Application Priority Data
Feb. 20, 2015 (JP) 2015-032343

(51) Int. Cl. H04W 36/36; H04W 72/04; H04W 76/04; H04W 72/12

(52) U.S. Cl. CPC H04W 36/36; H04W 72/0446; H04W 76/046; H04W 72/1268

(57) ABSTRACT

A user apparatus which performs communications with one or more base stations in a communication system which supports carrier aggregation is provided. The user apparatus includes a control unit configured to select a specific cell or a specific cell group as a reference of an uplink transmission carrier switching timing, from a plurality of cells or a plurality of cell groups with which the carrier aggregation is configured; and a transmission unit configured to perform switching from uplink transmission using a first cell carrier to uplink transmission using a second cell carrier based on a transient period timing in the selected specific cell or specific cell group.

### BACKGROUND OF THE INVENTION

### 1. Field of the Invention

The present invention relates to a technology in which a user apparatus in a mobile communication system which supports carrier aggregation switches uplink (UL) transmission between carriers.

### 2. Description of the Related Art

Carrier aggregation (CA) is adopted in an LTE system. In the carrier aggregation, communications are performed, by having a predetermined bandwidth as a basic unit, by using a plurality of carriers at the same time. The carrier as a basic unit in the carrier aggregation is referred to as a component carrier (CC).

When CA is performed, a primary cell (PCell) with high reliability for securing connectivity and a secondary cell (SCell) are set (configured) for a user apparatus UE. The user apparatus UE is first connected to a PCell, and, if necessary, a SCell can be added. The PCell is the same as a single cell which supports radio link monitoring (RLM) and semi-persistent scheduling (SPS), etc.

Adding and removing of a SCell is performed by radio resource control (RRC) signaling. Right after a SCell is configured for the user apparatus UE, the SCell is in a deactivated state. The SCell consequently becomes a cell capable of communications (capable of scheduling) when it is activated.

In CA up to LTE Rel-11, CA is performed by using a plurality of CCs under the same base station eNB. In Rel-12, dual connectivity (DC) is proposed in which simultaneous communications are performed to realize high throughput by using CCs under different base stations eNB (Non Patent Document 1). In dual connectivity, a user apparatus UE performs communications by simultaneously using radio resources of two physically different base stations eNB.

Dual connectivity (hereinafter referred to as DC) is a kind of CA, and is also referred to as Inter eNB CA (inter-base-station carrier aggregation). In DC, a master-eNB (MeNB) and a secondary-eNB (SeNB) are introduced.

In DC, a cell group including (one or multiple) cells under the MeNB is referred to as a master cell group (MCG), and a cell group including (one or multiple) cells under the SeNB is referred to as a secondary cell group (SCG). A MCG includes a PCell. It is possible for a MCG to include a SCell in addition to the PCell. A SCG includes one or more SCells. UL CC configuration is set in at least one SCell of a SCG. Physical uplink control channel (PUCCH) configuration is set in one of the SCells. Such a SCell is referred to as a primary SCell (PSCell).

### CITATION LIST

### Non-Patent Document

[Non-Patent Document 1] 3GPP TS 36.300 V12.4.0 (2014-12)
[Non-Patent Document 2] 3GPP TS 36.211 V12.4.0 (2014-12)

### SUMMARY OF THE INVENTION

### Technical Problem

In DC introduced in Rel-12, it is necessary for a user apparatus UE to have a capability to be configured with at least two UL CCs (UL component carriers) used for independently feeding back MAC-ACK/NACKs to multiple eNBs. Regarding an actual UE implementation aspect, it is known that it is difficult, from perspective of inter-modulation (IM), to implement UL simultaneous transmission with multiple CCs.

As a means to overcome implementation difficulty of UL simultaneous transmission, a control method has been proposed in which the number of CCs simultaneously transmitted per transmission time interval (TTI) of a scheduling unit period is limited, and transmission CCs are switched according to time. In other words, for example, as illustrated in FIG. 1, the user apparatus UE switches between UL CC in a MCG under the MeNB (e.g., UL CC of PCell) and UL CC in a SCG under the SeNB (e.g., UL CC of PSCell).

In this control method, a base station eNB performs scheduling in such a way that the user apparatus UE performs UL transmission via only a specific CC per TTI. Regarding a CC switching method, it is assumed that CCs are semi-statically switched at RRC level or dynamically switched at MAC/PHY level.

Regarding DC, in addition to synchronous DC in which inter-CC reception timing difference equivalent to CA is supported, asynchronous DC has been introduced in which inter-CC reception timing difference more than CA can be supported. For example, in Non-Patent-Document 1, it is defined that UE which performs synchronous DC operation can handle 33 μs reception timing difference between CGs, and that UE which performs asynchronous DC operation can handle 500 μs reception timing difference between CGs.

In asynchronous DC, a subframe boundary gap of about a half of a subframe (1 ms) between CGs may occur. Referring to FIG. 2 and FIG. 3, a problem of this case will be described.

FIG. 2 is a drawing illustrating an operation of the user apparatus UE when switching UL CCs in intra-eNB CA (or synchronous DC) (unless otherwise specified, “CC” means “UL CC” in the following). As illustrated in FIG. 2, the user apparatus UE performs UL transmission related to CA via CC#1 and CC#2. Further, for example, it is assumed that the user apparatus UE performs switching from CC#1 to CC#2 at the timing of a subframe indicated by “A”. Further, it is assumed that the switching between CCs requires some period, and the period is one subframe in this example (the same can be applied also to examples below). It should be noted that one subframe is merely an example. The period is referred to as transient period.

In this case, the user apparatus UE performs UL transmission via CC#1 until a subframe prior to a subframe A, and after going through the transient period, switches to UL transmission via CC#2. Because CC#1 and CC#2 are synchronized, time boundary of a subframe in CC#1 indicated by “A” matches that of a corresponding subframe in CC#2, and thus, the switching can be performed smoothly.

FIG. 3 illustrates an example of asynchronous DC. In FIG. 3, for example, CC#1 is CC of a cell in the MCG, and CC#2 is CC of a cell (a cell having UL) in the SCG. In FIG. 3, it is assumed that a subframe of the transient period indicated by “A” is, for example, subframe#0. In this case, the user apparatus UE performs switching in such a way that the user apparatus UE performs UL transmission via CC#1 before the transient period indicated by “A” and performs UL transmission via CC#2 from after a subframe next to the subframe#0 of the transient period.

However, in the case of asynchronous DC, subframe boundaries are not aligned between CC#1 and CC#2, and thus, a subframe of CC#1 indicated by “B” overlaps with the subframe#0 corresponding to the transient period in CC#2. Therefore, there is a possibility that, in this subframe, the user apparatus UE cannot perform UL transmission via CC#1 normally. Further, a subframe of CC#2 indicated by “C” overlaps with the subframe #0 corresponding to the transient period in CC#1, and thus, there is a possibility that, in this subframe, the user apparatus UE cannot perform UL transmission via CC#2 normally.

In other words, in asynchronous DC, subframe boundaries are not aligned between switching CCs, and thus, there is a possibility that the user apparatus UE cannot perform UL transmission normally before and after the transient period, which is a problem.

In view of the above, an object of the present invention is to provide a technique in which it is possible for a user apparatus UE, in a mobile communication system which supports carrier aggregation, to appropriately perform UL transmission by time switching between carriers even in the case where multiple cells configured for the carrier aggregation are asynchronous.

### Solution to Problem

According to an embodiment, a user apparatus performing communication with one or more base stations in a mobile communication system which supports carrier aggregation is provided. The user apparatus includes a control unit configured to select a specific cell or a specific cell group as a reference of a UL transmission carrier switching timing, from the cells or cell groups configured for carrier aggregation; and a transmission unit configured to perform switching from the UL transmission using a first cell carrier to the UL transmission using a second cell carrier based on a timing of a transient period in the selected specific cell or the selected specific cell group.

Further, according to an embodiment, a UL transmission switching method performed by a user apparatus performing communications with one or more base stations in a mobile communication system which supports carrier aggregation is provided. The UL transmission switching method includes a step of selecting a specific cell or a specific cell group as a reference of a UL transmission carrier switching timing, from the cells or cell groups configured for the carrier aggregation; and a step of performing switching from the UL transmission using a first cell carrier to the UL transmission using a second cell carrier based on a timing of a transient period in the selected specific cell or the selected specific cell group.

### Advantageous Effects of Invention

According to an embodiment, it is possible for a user apparatus in a mobile communication system which supports carrier aggregation to appropriately perform UL transmission by timed switching between carriers even in the case where multiple cells configured for the carrier aggregation are asynchronous.

### BRIEF DESCRIPTION OF THE DRAWINGS

FIG. 1 is a drawing illustrating performing time switching of UL transmission in dual connectivity (DC).

FIG. 2 is a drawing illustrating a problem.

FIG. 3 is a drawing illustrating a problem.

FIG. 4 is a drawing illustrating a structure example of a communication system according to an embodiment of the present invention.

FIG. 5 is a drawing illustrating a process example related to DC configuration in a communication system according to an embodiment.

FIG. 6 is a drawing illustrating a UE operation in the case where a specific cell is a reference of a timing of a transient period.

FIG. 7 is a flowchart of a UE operation.

FIG. 8A is a drawing illustrating an example of a specific cell/CG as a reference of a timing of a transient period.

FIG. 83 is a drawing illustrating an example of a specific cell/CG as a reference of a timing of a transient period.

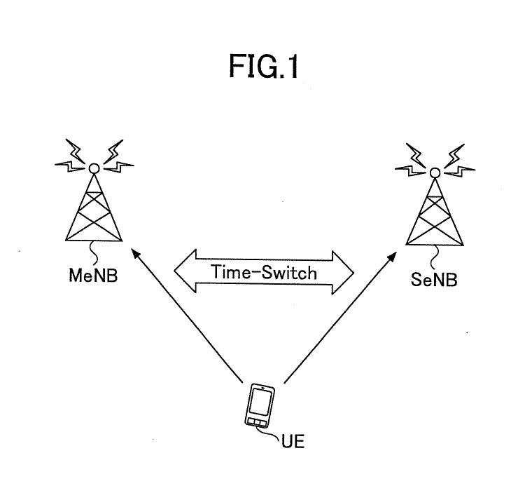

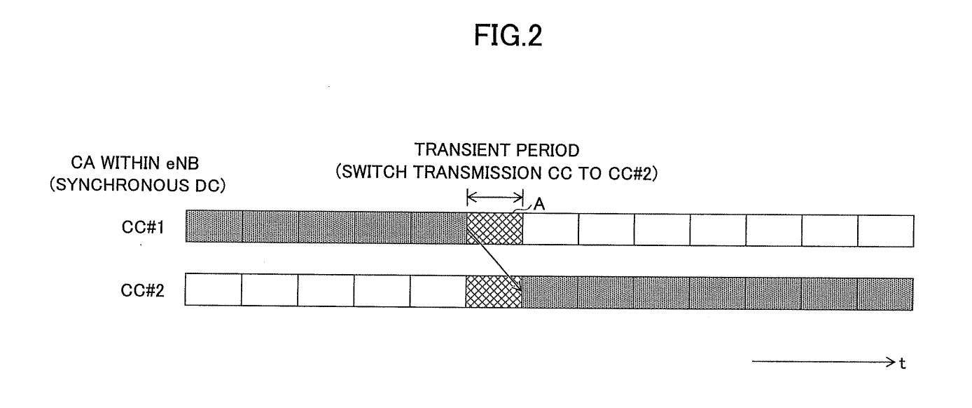

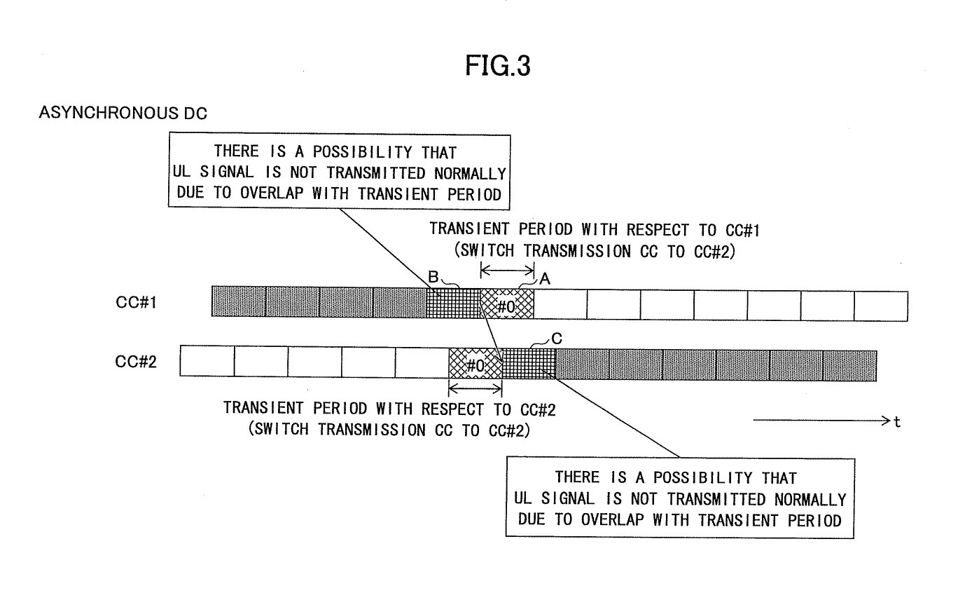

FIG. 9 is a drawing illustrating a sequence example in the case where a specific cell/CG as a reference of a timing of a transient period is specified by a base station.

FIG. 10 is a drawing illustrating an example of a case where priority is set in each of 3 CGs.

FIG. 11 is a drawing illustrating a UE operation in the case where priority is set in each of 3 CGs.

FIG. 12 is a drawing illustrating a structure example of a communication system in a modified example 2.

FIG. 13 is a drawing illustrating an operation example at the time of switching from LTE to 5G in a modified example 2.

FIG. 14 is a drawing illustrating an operation example at the time of switching from 5G to LTE in a modified example 2.

FIG. 15 is a drawing illustrating a procedure example in a modified example 3.

FIG. 16 is a drawing illustrating a structure of a user apparatus UE.

FIG. 17 is a hardware configuration diagram of the user apparatus UE.

FIG. 18 is a drawing illustrating a structure of a base station eNB.

FIG. 19 is a hardware configuration diagram of the base station eNB.

### DETAILED DESCRIPTION OF THE PREFERRED EMBODIMENTS

In the following, referring to the drawings, embodiments of the present invention will be described. It should be noted that the embodiments described below are merely examples and the embodiments to which the present invention is applied are not limited to the following embodiments. In an embodiment, a target is an LTE mobile communication system. However, an embodiment is not limited to LTE, and can be applied to other mobile communication system in which carrier aggregation is employed.

In the following, a cell group (CG) including multiple cells configured for CA is used. A MCG and a SCG in DC are examples of a CG. However, a CG is a concept not limited to a MCG and a SCG. A group in which multiple cells are grouped from a certain aspect is referred to as a CG. Further, a CG includes a case where only one cell is included. In an embodiment, it is assumed, but not limited to, that cells in the same CG are synchronized and CGs are not synchronized. Further, in the following, carrier aggregation (CA) is, unless otherwise specified, used as including DC.

A “cell” configured for CA is a cell in which the user apparatus UE resides, and may be referred to as a serving cell. Further, as an example, a “cell” configured for CA includes only DL CC, or includes DL CC and UL CC. Further, it is assumed that the release of 3GPP specifications of “LTE” in this application specification and claims may be, but not limited to, any release in which CA is introduced.

(Overall System Configuration)

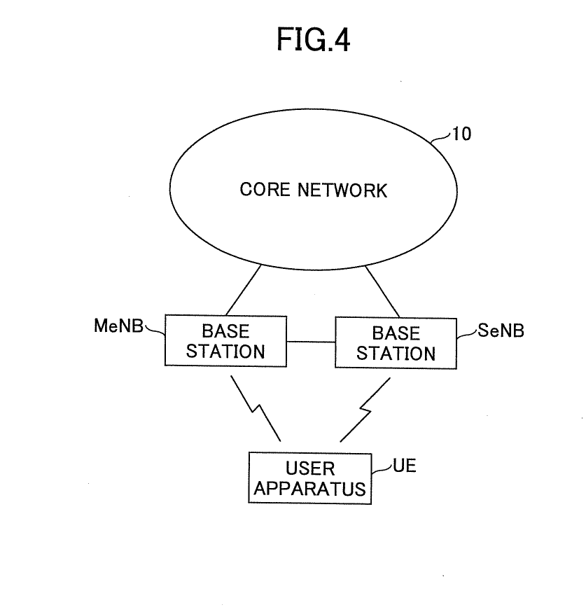

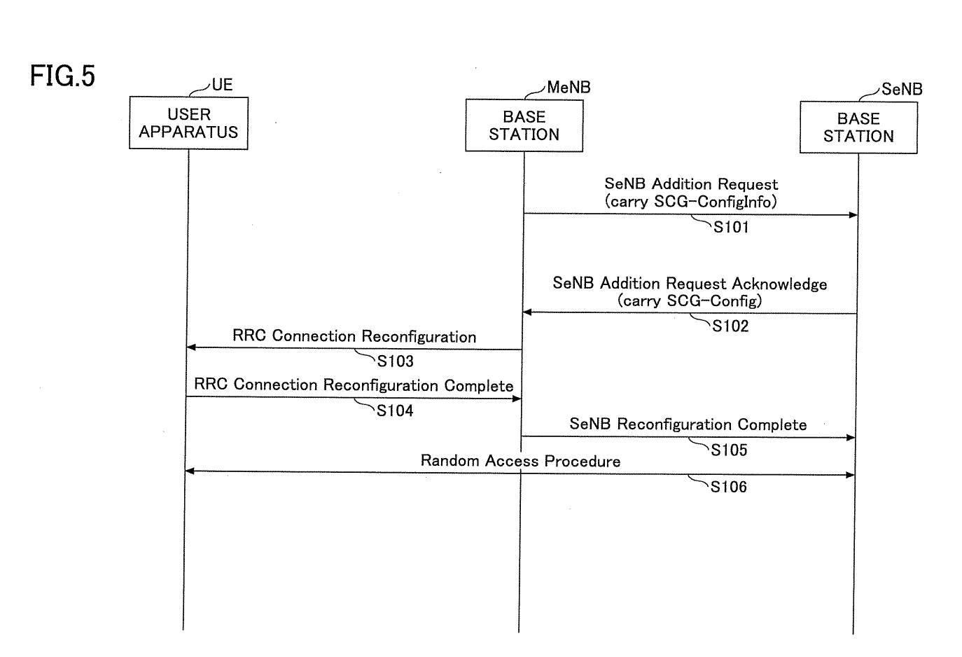

FIG. 4 illustrates a configuration example of a mobile communication system according to an embodiment of the present invention. As illustrated in FIG. 4, the mobile communication system according to an embodiment includes a base station MeNB and a base station SeNB connected to a core network 10, respectively, and thus, dual connectivity is available between the user apparatus UE and the base stations. Further, communications can be performed between the base station MeNB and the base station SeNB via, for example, X2 interface. In an embodiment, unless otherwise specified, it is assumed that DC is asynchronous DC. However, a control method described in an embodiment may be applied to a synchronous DC or may be applied to CA which is not DC.

It should be noted that, in the following description, basically, a user apparatus is described as UE, and a base station MeNB and a base station SeNB are described as MeNB and SeNB, respectively. Further, a single base station is described as eNB, and in the case where the base stations MeNB and SeNB are not distinguished, the base station is described as eNB.

(Basic Operation Example of Communication System)

First, as a basic operation example of a communication system illustrated in FIG. 4, referring to FIG. 5, an operation sequence example for setting DC configuration by adding a SeNB (SCG) for a UE is described.

For example, in the case where a MeNB determines to set DC configuration for the UE based on measurement report, etc., from the UE, the MeNB transmits a SeNB addition request to the SeNB (step S101). In the SeNB addition request, MCG configuration information, etc., are included. The SeNB returns SeNB addition request acknowledgment to the MeNB (step S102). In the SeNB addition request acknowledgment, SCG radio resource configuration information, etc., are included.

The MeNB transmits a SeNB addition indication (RRC connection reconfiguration) to the UE (step S103). In the SeNB addition indication, SCG radio resource configuration information, etc., are included. The UE performs SCG addition by applying the configuration information, and returns a configuration complete (RRC connection reconfiguration complete) to the MeNB (step S104). The MeNB returns a configuration complete (SeNB reconfiguration complete) indicating successful reconfiguration at the UE to the SeNB (step S105). Afterwards, the UE establishes synchronization with the SCG by performing random access procedure for the SCG (PSCell) (step S106).

As an example, according to a procedure described above, DC configuration between the UE and MeNB/SeNB is set, and DC communications become available.

(Control Related to CC Switching)

In an embodiment, unless otherwise specified, the UE performs DC UL communications by using multiple CCs (e.g., two CCs). Further, the multiple CCs are included in asynchronous CGs (e.g., a MCG and a SCG, multiple SCGs). Further, the UE switches the multiple CCs via a transient period, and thus, the UE performs UL transmission by always using a single CC in a time direction.

With the prerequisite described above, in an embodiment, in order to solve a problem caused by a gap between the subframe boundaries of CCs, it is assumed that the UE performs switching between CCs by having a timing of a transient period in a cell included in a specific CG as a reference. It should be noted that, in the case where the UE performs UL transmission by using two CCs, the above “cell included in a specific CG” can be specified to be a single cell (e.g., PCell). Therefore, in the following, a thing as a reference of a transient period timing is described as a specific cell/CG (which means a specific cell or a specific CG).

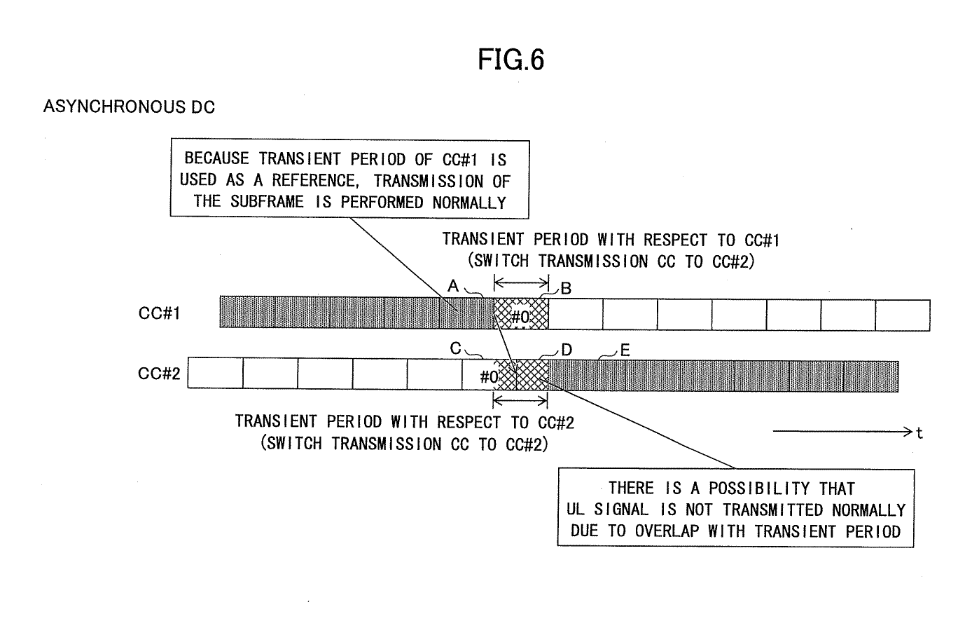

Referring to FIG. 6, an operation example of UL transmission by the UE in the case where the UE performs UL transmission via two CCs (CC#1 and CC#2) will be described. It should be noted that FIG. 6 may be considered to illustrate switching between two CCs in the case where the UE performs UL transmission via three or more CCs.

In an example illustrated in FIG. 6, it is assumed that the UE performs switching between CCs by having a timing of a transient period in CC#1 as a reference. CC#1 is, for example, CC of a cell, including UL, included in a MCG (e.g., PCell). CC#2 is, for example, CC of a cell, including UL, included in a SCG (e.g., PSCell).

In an example illustrated in FIG. 6, the UE, the MeNB, and the SeNB are configured to perform switching between CCs having a subframe#0 as a transient period, and configuration indicating that the transient period is a subframe is set. The above configuration contents are determined, for example, by the MeNB, and transmitted to the SeNB and the UE in steps S101 and S103 illustrated in FIG. 5. Further, information indicating that the timing of CC#1 is a switching reference may be transmitted from the MeNB (or the SeNB) to the UE, or the information may be obtained by each apparatus according to a predetermined rule which will be described later.

In FIG. 6, the UE performs UL transmission via CC#1 up to a subframe of CC#1 indicated by “A”. In other words, up to the subframe of CC#1 indicated by “A”, UL transmission allocation (scheduling) for the UE is provided by an eNB (e.g., MeNB).

Because a subframe of CC#1 indicated by “B” is in the transient period, the scheduling by the eNB via CC#1 is not provided. Further, the UE performs switching UL transmission from via CC#1 to via CC#2. “Switching from via CC#1 to via CC#2” means, for example, to switch frequency of a transmitter from CC#1 to CC#2.

The eNB (e.g., SeNB) recognizes that a subframe #0 in CC#2 indicated by “C” is in the transient period, and starts UL transmission allocation for the UE from a subframe indicated by “D”. On the other hand, the UE recognizes the period of a subframe of CC#1 indicated by “B” as the transient period. Therefore, the UE detects that the period of a subframe in CC#2 indicated by “D” overlaps with the transient period, does not perform UL transmission via CC#2 during the period of a subframe indicated by “D”, and starts UL transmission via CC#2 from the following subframe indicated by “E”. With the above operation, for example, it is possible to avoid performing abnormal UL transmission during a transient period.

It should be noted that, in FIG. 6, in the case where the priority of CC#2 is higher than that of CC#1, and thus, CC#2 is considered as a reference, the UL transmission via the subframe of CC#1 indicated by “A” is stopped because the subframe indicated by “A” overlaps the transient period in CC#2.

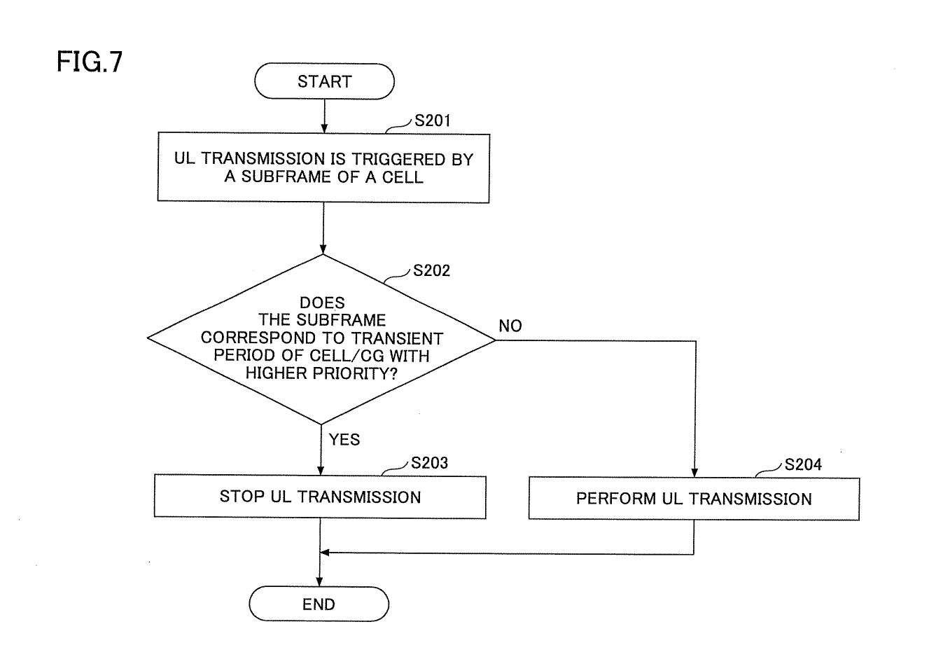

Referring to FIG. 7, an example of an operation flow at the time of switching between CCs by the UE will be described. In an example of FIG. 7, priority is defined for each of the cells/CGs, and it is assumed that the switching between CCs is performed by having a timing of a cell/CG with higher priority as a reference.

First, for example, an eNB of a cell performs UL transmission allocation for a UE, and the UE is triggered to perform UL transmission via a subframe of the cell (step S201). The UE determines whether at least a part of the subframe overlaps a transient period in another cell (cell of another CC) with priority higher than the cell (via CC of which cell the UL transmission has been triggered) (step S202).

“A part overlaps” in step S202 means that, for example, there is an overlap for a time equal to or greater than a threshold value. Further, “another cell with priority higher than the cell” includes a case where the other cell belongs to a CG whose priority is higher than the priority of a CG to which the cell belongs.

In the case where the determination in step S202 is YES, the UE does not perform the triggered UL transmission (step S203). The above case corresponds to a case where the UL transmission triggered subframe is a subframe of CC#2 indicated by “C” or “D” illustrated in FIG. 6. Further, in the case where the determination in step S202 of FIG. 7 is NO, the UE performs the UL transmission (step S204).

(Selection Method of Specific Cell/CG)

Next, a method of selecting, by the UE, a specific cell/CG which the UE has as a reference of the switching between CCs will be described. The specific cell/CG may be selected by the UE autonomously, or may be selected based on an instruction from the eNB.

<An Example in which the UE Autonomously Selects a Specific Cell/CG>

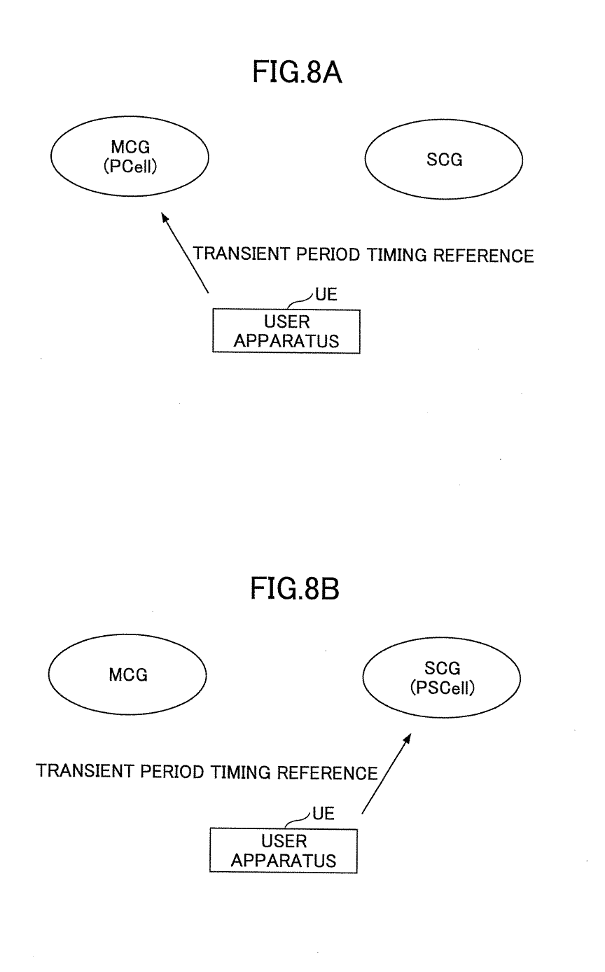

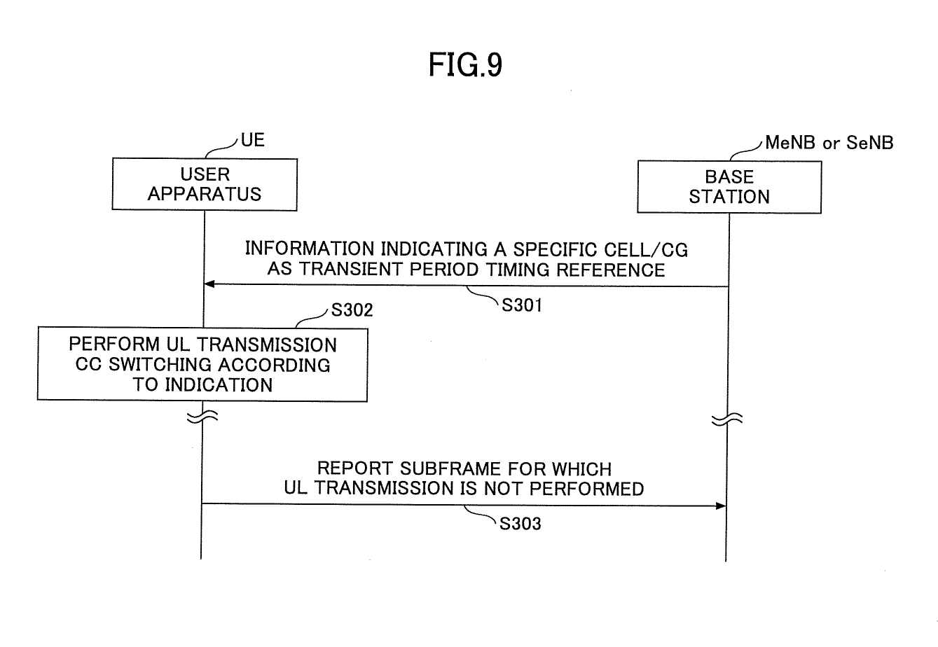

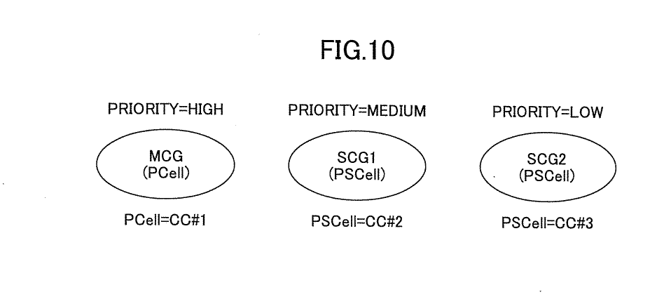

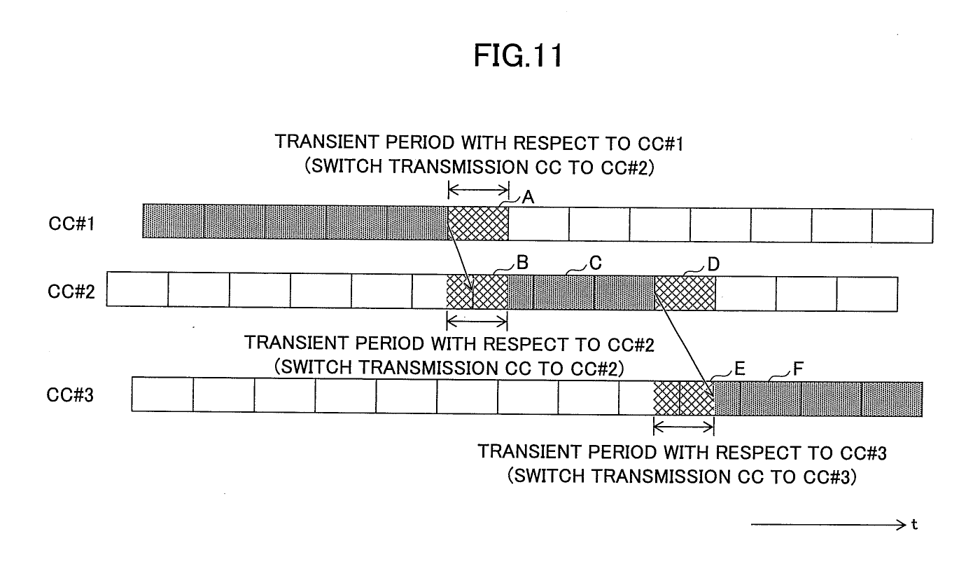

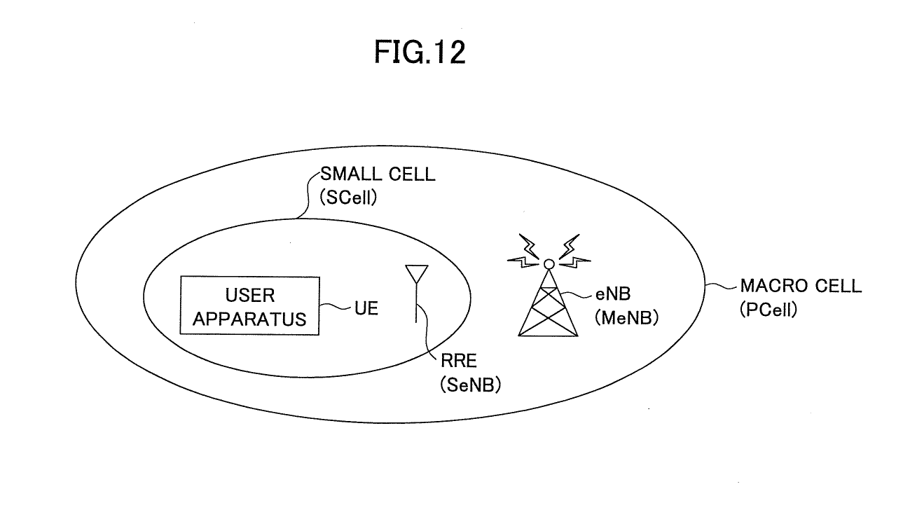

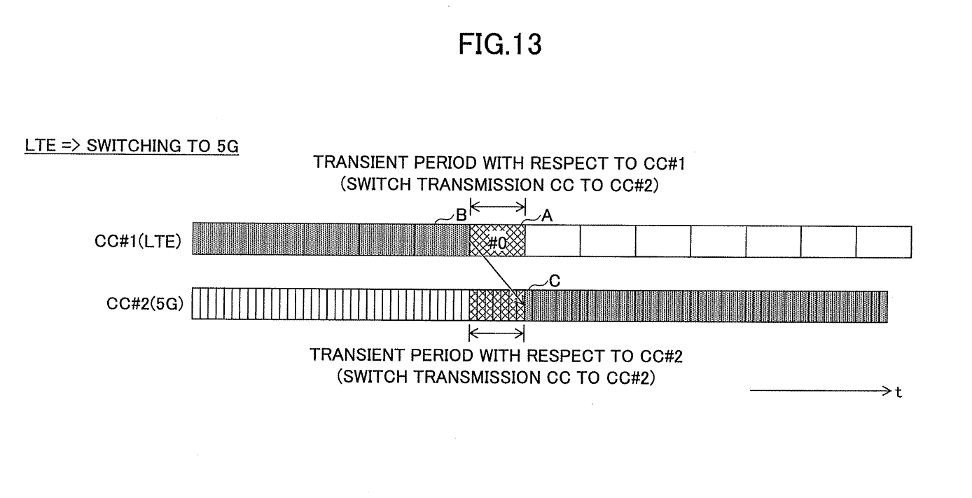

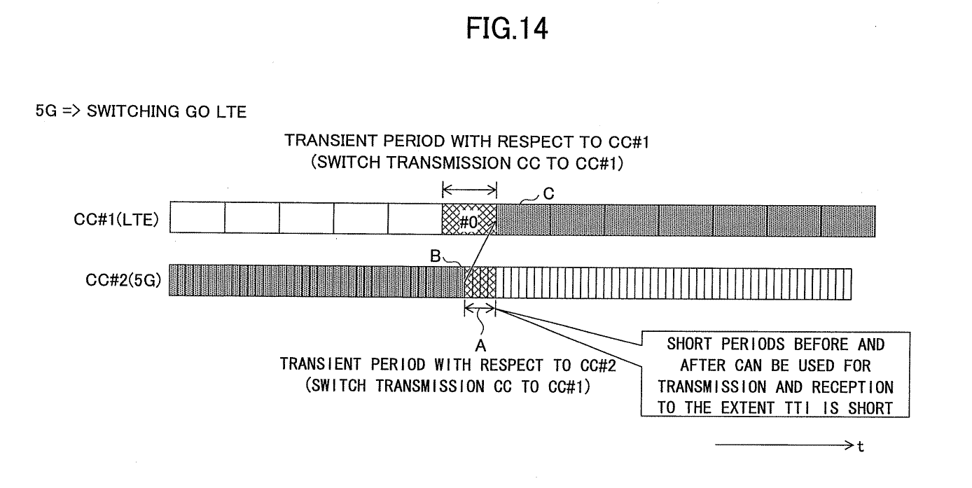

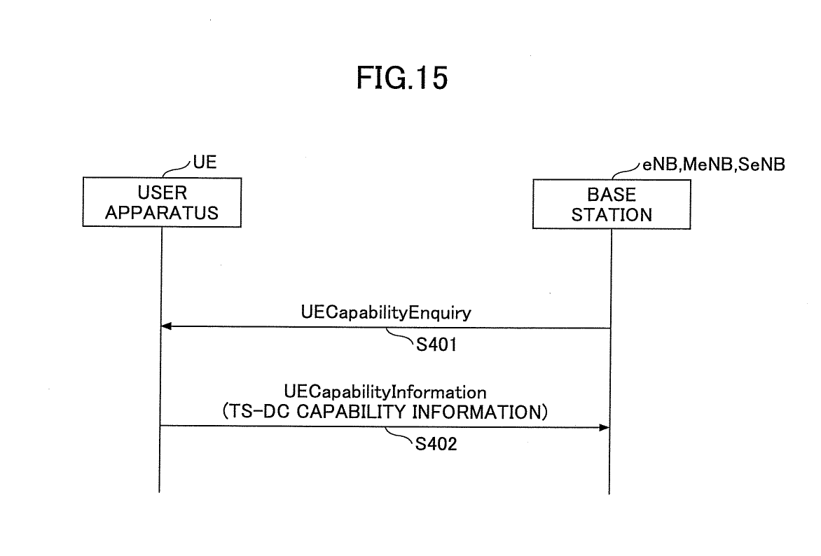

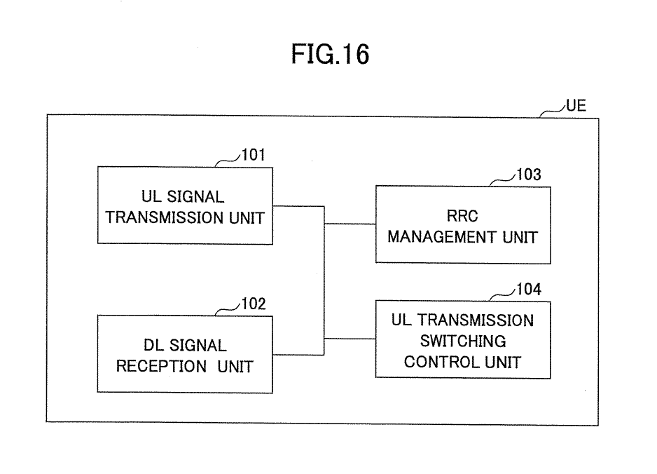

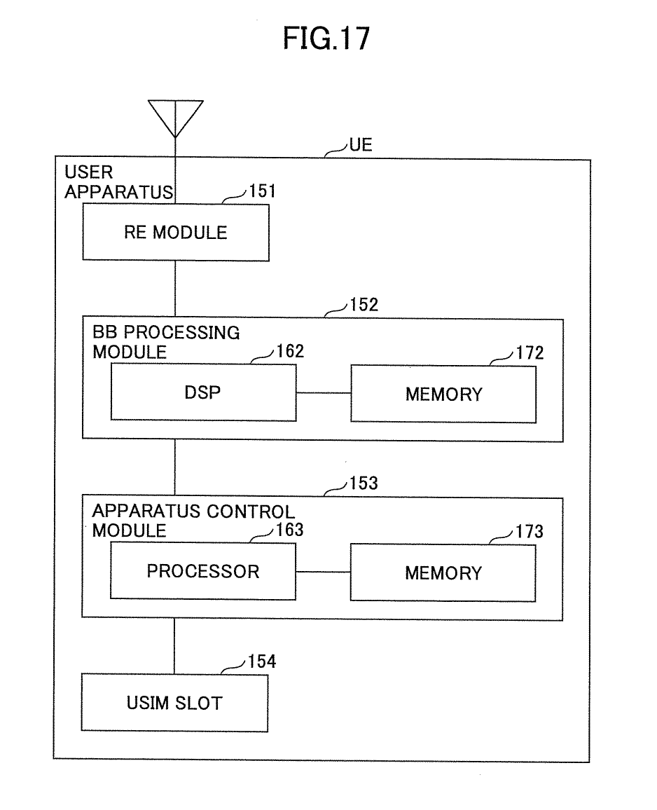

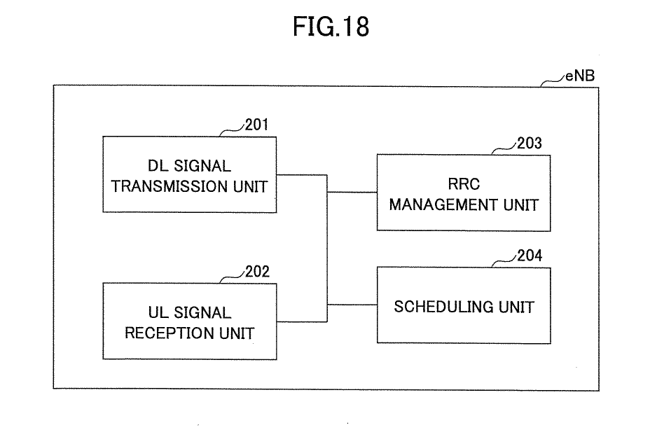

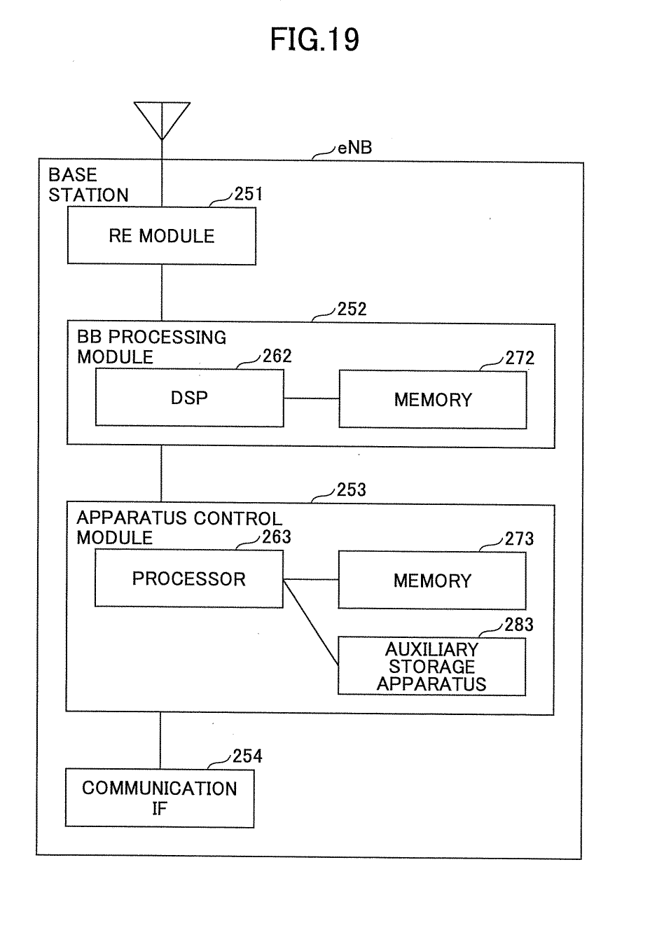

In the case where the UE autonomously selects a specific cell/CG, for example, as illustrated in FIG. 8A, the UE selects as a specific CG a MCG which is a CG including a PCell, out of two CGs (a MCG and a SCG) to which the CCs belong, while the UE performs UL transmission via the CCs, and has the cell which belongs to the MCG (a cell of one of the two CCs) as a timing reference. The cell which belongs to the MCG may be a PCell or a cell other than the PCell in the MCG (a cell including UL CC).

Further, for example, in the case where cells to which the two CCs used for the UL transmission belong are a PCell and a PSCell, the UE may select the PCell as a specific cell. It should be noted that the above case is the same as selecting the MCG as a specific CG.

As described above, it is possible to protect transmission and reception of the PCell side and to secure connectivity by selecting the CG including the PCell (MCG) as a specific CG as a timing reference of the switching between CCs.

Further, for example, as illustrated in FIG. 8B, the UE may select as a specific CG the SCG which includes the PSCell, out of two CGs (MCG and SCG) to which the CCs belong while the UE performs the UL transmission via the CCs, and have the cell which belongs to the SCG (a cell of one of the two CCs) as a timing reference. A cell which belongs to the SCG may be a PSCell or a cell other than the PSCell in the SCG (a cell including UL CC).

Further, for example, in the case where cells to which the two CCs used for the UL transmission belong are a PCell and a PSCell, the UE may select the PSCell as a specific cell. It should be noted that the above case is the same as selecting the SCG as a specific CG.

As described above, it is possible to protect transmission and reception of the PSCell side and to perform offloading of user plane (UP) more efficiently by selecting the CG including the PSCell (SCG) as a specific CG used as a timing reference of the switching between CCs.

Further, the UE may determine the specific cell/CG by the size of cell index/CG index. For example, in the case where the indexes of two CGs, to which CCs via which the UL transmission is performed belong, are 1 and 2, the UE selects a CG with a smaller index (or bigger index) as a specific CG. Further, for example, in the case where the indexes of two cells, to which CCs via which the UL transmission is performed belong, are 1 and 5, the UE selects a cell with a smaller index (or bigger index) as a specific cell. As examples of cell/CG index, there are CellIndex, SCellIndex, CGIndex, etc.

To have a cell/CG with a smaller index (or a bigger index) as a specific cell/CG may be matter predefined between the UE and the eNB (MeNB, SeNB), or the eNB determines to have a cell/CG with a smaller index (or a bigger index) as a specific cell/CG, and the determined contents may be transmitted to the UE.

Further, the UE may select a cell/CG which is configured with a specific bearer or a specific logical channel (LCH) as a specific cell/CG. For example, the UE selects a cell/CG, out of two cells (CGs) which the two CCs belong to, which is configured with a bearer (or LCH) with higher QoS (an example of communication path priority) as a specific cell/CG. With the above control method, transmission and reception in a communication path (bearer, LCH, etc.,) which requires higher quality can be protected.

Further, the UL may select a specific cell/CG based on channel types (signal types) of UL transmission in the cells/CGs which perform UL transmission. For example, a cell/CG, of the cells/CGs, which transmits PUCCH may be selected as a specific cell/CG. Further, for example, a cell/CG, of the cells/CGs, which transmits PRACH may be selected as a specific cell/CG. Further, for example, a cell/CG, of the cells/CGs, which transmits a specific signal (e.g., SR, ACK/NACK) may be selected as a specific cell/CG. Further, for example, an existing rule of power scaling or dropping may be used.

It should be noted that the various methods of selecting a specific cell/CG described above may be combined to be performed. For example, in the case where multiple candidates are selected in a selection method, a specific cell/CG can be selected from the candidates by using another selection method.

<An Example in which the UE Selects a Specific Cell/CG Based on an Instruction from the eNB>

As described above, the UE may select a specific cell/CG based on an instruction from the base station eNB. In this case, an instruction-transmitting side (eNB) may select a specific cell/CG with the same method as in the case where the selection is performed by the UE, or may select a specific cell/CG based on another policy.

As described above, it becomes possible to flexibly select a specific cell/CG based on a network side policy by selecting a specific cell/CG based on an instruction from the eNB side.

FIG. 9 illustrates a sequence example of this case. In step S301, the eNB (e.g., MeNB or SeNB) specifies a specific cell/CG which is a timing reference of a transient period between CCs. The specification may be performed by using a cell index/a CG index, etc.

Further, the specifying in step S301 may be performed at the same time as the adding of the SeNB in step S103 illustrated in FIG. 5 by using an RRC signal. Further, the specifying in step S301 may be performed dynamically by using a MAC signal or a PHY signal (PDCCH, etc.) Further, at the specifying in step S301, information about which subframe is used for switching (which subframe is considered as a transient period), and the length of the transient period (the number of subframes) may be transmitted from the eNB to the UE.

In step S302, the UE performs CC switching in UL transmission by having the cell/CG specified in step S301 as a timing reference.

Further, as illustrated in step S303, in the case where the UE receives a UL transmission trigger in a CC and the UE is unable to perform UL transmission via the CC due to the transient period of another CC, the UE may transmit a report on unperformed UL transmission from a physical layer (e.g., radio unit) to an upper layer (e.g., control unit for controlling MAC, RRC, etc.,), and the unperformed UL transmission may be reported to the eNB according to the upper layer determination. In the report, for example, an index of a cell in which the UL transmission was not performed, or a number of a subframe not transmitted in the UL transmission, etc., may be included. With the report described above, the eNB recognizes that the UE was unable to perform the UL transmission in spite of the UL transmission allocation, and, for example, utilizes the recognition for the subsequent scheduling.

It should be noted that the report in step S303 may be performed regardless whether the UE selects a specific cell/CG autonomously or based on the instruction from the eNB.

Further, the instruction contents in step S301 may be a specification of a specific cell/CG, or a method of selecting a specific cell/CG (selection method described above).

Mainly an example of switching between two CCs has been described above. The two CCs may not be limited to a case where the UE has capability of two UL CCs. The two CCs may be any two CCs of three or more CCs in the case where the UE has CA capability with three or more UL CCs and three or more UL CCs are included in CA configuration.

### Modified Example 1

In FIG. 4, a case is illustrated in which there is one SeNB (SCG), which is just an example, and there may be two or more SCGs. In other words, the number of CGs which are configured for DC may be three or more. In this case, a specific cell/CG may be selected between any two CGs (corresponding to two CCs between which the switching is performed) also in a way described above.

Further, priority of each of the cells/CGs may be predefined, and the priority is set beforehand among the UE, MeNB, and SeNB. Further, for example, the MeNB may determine the priority of each of the cells/CGs, and transmit the priority to the UE and the SeNB.

As an example, as illustrated in FIG. 10, in the case where, of three CCs (CC#1, CC#2, CC#3) the UE uses for UL transmission, priority of a CG to which CC#1 belongs is defined as high (relative priority among the three CGs), priority of a CG to which CC#2 belongs is defined as medium, and priority of a CG to which CC#3 belongs is defined as low, the priority order among the CCs is CC#1>CC#2>CC#3.

Referring to FIG. 11, an operation example of the UE at the time of switching between the CCs in this case will be described. The UE performs UL transmission via CC#1 first, and performs switching from CC#1 to CC#2 during a transient period of a subframe indicated by “A”. Because the timing of CC#1 is a reference between CC#1 and CC#2, UL transmission is not performed with a subframe of CC#2 indicated by “B” (overlaps a transient period of the reference), and UL transmission is performed from a subframe indicated by “C”. Next, the UE performs switching from CC#2 to CC#3 during a transient period of a subframe indicated by “D”. Because the timing of CC#2 is a reference between CC#2 and CC#3, UL transmission is not performed with a subframe of CC#3 indicated by “E” (overlaps a transient period of the reference), and UL transmission is performed from a subframe indicated by “F”.

### Modified Example 2

In the existing LTE, as a radio frame structure, it is defined that 1 radio frame is 10 ms, 1 subframe is 1 ms, 1 slot is 0.5 ms (Non-Patent Document 2). One subframe corresponds to a transmission time interval (TTI) which is a minimum unit of scheduling. In other words, for each subframe, a resource block (RB) is allocated to a UE selected by the scheduling of the eNB. One RB includes, for example, 12 subcarriers in frequency direction (subcarriers of OFDM) and 7 symbols in time direction (symbols of OFDM).

It should be noted that in the 3rd generation partnership project (3GPP), it is planned that the standardization of the fifth generation wireless technology (hereinafter, referred to as “5G”) will be started from Rel-14 or later. In 5G, shortening a TTI (e.g., shortening to 0.1 ms) to reduce radio communication delay has been investigated.

Further, as an operation form of the 5G, an operation has been investigated in which the CA is performed by having the LTE cell as a base and having the 5G cell overlaid. An example of the above operation form is illustrated in FIG. 12. As illustrated in FIG. 12, an LTE cell as a macro cell (PCell) is formed by a base station eNB, a 5G cell as a small cell (SCell) is formed by, for example, remote radio equipment (RRE) extended from the eNB, and a UE performs high-throughput communications by using CA via the LTE cell and the 5G cell. Further, the configuration illustrated in FIG. 12 may be DC configuration. In this case, for example, a NeNB forms a LTE macro cell (MCG), and a SeNB forms a 5G small cell (SCG).

The configuration of a mobile communication system of the modified example 2 may be the configuration of (asynchronous or synchronous) DC illustrated in FIG. 4, or the configuration of CA illustrated in FIG. 12.

As described above, in the case where CA (including DC) is performed by LTE and 5G, multiple CCs with different TTI lengths are bundled in UL transmission of the UE. Here, for example, in the case where a transient period between LTE CCs is a subframe in LTE (TTI length of LTE, referred to as an LTE subframe), and a transient period between 5G CCs is a subframe in 5G (TTI length of 5G, referred to as a 5G subframe), if the switching between CCs is between a same RAT, then the switching between CCs can be performed by applying the transient period of the RAT. However, in the case where the switching is performed between the LTE CC and the 5G CC, it is not clear which transient period is applied.

Therefore, in the modified example 2, the transient period in the transition between CCs of different RATs in UL CA is defined according to a transition direction. In the modified example 2, an example of transition between LTE and 5G as different RATs is described. RATs are not limited to LTE and 5G. It is possible to use other RATs with which CA (including DC) is configured.

Referring to FIG. 13 and FIG. 14, in the case where the UE performs UL transmission via multiple CCs including an LTE CC and a 5G CC, a UE operation example when the switching is performed between the LTE CC and the 5G CC will be described. “The UE performs UL transmission via multiple CCs including an LTE CC and a 5G CC” may mean that the UE performs CA (not DC) under the same eNB by using the LTE CC and the 5G CC, or may mean that the UE performs DC by using a CG to which the LTE CC belongs (e.g., MCG) and a CG to which the 5G CC belongs (e.g., SCG). Further, the DC may be asynchronous or synchronous. Further, in an example, it is assumed that information indicating that the switching is performed in a subframe#0 of LTE (RAT of longer TTI) is set in the UE and the eNB (MeNB, SeNB).

FIG. 13 is an example in the case where the UE performs the switching from LTE CC#1 to 5G CC#2. In this case, the UE performs the switching from CC#1 to CC#2 (5G) by having a subframe#0 in CC#1 (LTE) indicated by “A” as a transient period. In other words, the UE performs UL transmission via CC#1 up to the LTE subframe indicated by “B”, having an LTE subframe (a period indicated by “A”) as a transient period, does not perform UL transmission via CC#1 or via CC#2 during the period, and starts UL transmission via CC#2 from a 5G subframe indicated by “C”. It should be noted that, here, a transient period from LTE to 5G is one LTE subframe amount, which is known and set beforehand in the UE and the eNB. Alternatively, information indicating that the transient period from LTE to 5G is one LTE subframe amount may be transmitted from the eNB to the UE via an RRC signal, etc., to be set in the UE.

Further, that the transient period from LTE to 5G is one LTE subframe amount is just an example, and the transient period may be longer or shorter than an LTE subframe depending on the UE capability.

FIG. 14 is an example of a case where the UE performs switching from 5G CC#2 to LTE CC#1. In this case, the UE performs switching from CC#2 to CC#1 (LTE) by having four 5G subframes in CC#2 (5G) indicated by “A” as a transient period.

In other words, the UE performs UL transmission via CC#2 up to a 5G subframe indicated by “B”, having four 5G subframes (period indicated by “A”) as a transient period, does not perform UL transmission via CC#1 or via CC#2 during the period, and starts UL transmission via CC#1 from an LTE subframe indicated by “C”.

In this example, the UE detects a transition timing at the start of an LTE subframe#0, and, knowing that the transition from 5G to LTE can be performed during the four 5G subframes period, the UE continues performing UL transmission via 5G up to a 5G subframe indicated by “B”.

It should be noted that, here, that the transient period from 5G to LTE is a period of four 5G subframes is just an example, and the transient period may be longer or shorter than the period of four 5G subframes depending on the UE capability. Further, the UE can determine the transient period from an LTE cell CC to a 5G cell CC, and the transient period from a 5G cell CC to an LTE cell CC, and the transient periods can be applied when corresponding switching operations are performed. The above transient periods may be set (retained) in the UE and the eNB, or may be transmitted from the eNB to the UE via an RRC signal, etc., to be set in the UE.

Further, in examples of FIG. 13 and FIG. 14, an LTE side is used as a reference timing of transition between the CCs, but a 5G side may be used as a reference. Which side is used as a reference may be determined according to the above described method of selecting a specific cell/CG. As an example, in the case where a PCell is configured with LTE and a PSCell is configured with 5G, LTE can be used as a reference of transition timing between CCs. Further, a cell/CG of a RAT whose TTI length is longer (or shorter) may be a specific cell/CG, and may be a reference of transition timing.

### Modified Example 3

Information on whether the UE supports a function of transitioning between CCs in DC UL transmission may be transmitted as capability information from the UE to the eNB (MeNB in this example). It should be noted that the above function of transitioning between CCs in DC UL transmission is referred to as time switched DC (TS-DC). The MeNB that has received TS-DC capability information can determine, for example, whether it is possible to configure the UE for UL CA with asynchronous multiple cells.

Referring to FIG. 15, a procedure example in the modified example 3 will be described. Here, it is assumed that the base station is a MeNB, but the base station may be an eNB or a SeNB with which DC is not configured.

In step S401, the UE receives a UE capability inquiry from the MeNB. In step S402, the UE transmits UE capability information to the MeNB.

For example, the UE transmits information (including transmitting as information included in the UE capability information) indicating whether the UE supports TS-DC to the MeNB as the UE capability information. In other words, UE as a unit performs the transmission. Here, it is assumed that the UE, that has transmitted information indicating that the UE has TS-DC capability, is capable of supporting TS-DC regardless of synchronous or asynchronous for any band combination that supports UL DC.

Further, the UE may transmit information indicating whether the UE supports TS-DC for each of synchronous DC and asynchronous DC as the UE capability information. In other words, for example, the UE transmits information indicating that the UE is capable of TS-DC for synchronous DC but is not capable of TS-DC for asynchronous DC (does not have a function described in an embodiment).

The UE, which transmits information indicating that the UE is capable of synchronous TS-DC, supports TS-DC for a band combination that supports synchronous DC. Further, the UE, which transmits information indicating that the UE is capable of asynchronous TS-DC, supports TS-DC for a band combination that supports asynchronous DC.

Further, the UE may transmit information on whether the UE is capable of TS-DC for each band combination. The UE, which transmits the above capability information, supports TS-DC for corresponding band combinations. Further, the UE may transmit capability information indicating whether the UE is capable of TS-DC even in a subset level of the band combinations.

Further, the UE may transmit a required transient period in the TS-DC capability information transmission. The required transient period may be transmitted by transmission of, for example, a time required as a transient period (e.g., μs), the number of TTIs in LTE or 5G (the number of subframes), etc.

Embodiments including modified examples have been described above. The user apparatus UE may include all functions for performing the processes described above, or may include a part of the functions.

### Apparatus Structure Example

Next, main configurations of the UE and the eNB capable of performing all processes described above will be described.

First, a functional structure of the UE according to an embodiment is illustrated in FIG. 16. As illustrated in FIG. 16, the UE includes a UL signal transmission unit 101, a DL signal reception unit 102, an RRC management unit 103, and a UL transmission switching control unit 104. FIG. 16 only illustrates functional units especially related to an embodiment. The UE further includes at least functions for performing operations according to LTE (not shown in the figure). Further, a functional structure illustrated in FIG. 16 is only an example. Functional classification and names of functional units may be anything as long as operations related to an embodiment can be performed.

The UL signal transmission unit 101 includes a function for wirelessly transmitting various kinds of physical layer signals generated from an upper layer signal which should be transmitted from the UE. The UL signal reception unit 102 includes a function for wirelessly receiving various kinds of signals from the eNB, and obtaining upper layer signals from the received physical layer signals. Each of the UL signal transmission unit 101 and the DL signal reception unit 102 includes a function for performing CA (including DC) in which multiple CCs are bundled for communications. It should be noted that, regarding UL transmission performed by the UL signal transmission unit 101, CA communications are performed by switching between CCs according to time.

It is assumed that each of the UL signal transmission unit 101 and the DL signal reception unit 102 includes a packet buffer, and performs processes of layer 1 (PHY) and layer 2 (MAC, RLC, PDCP). However, the functional structure is not limited to the above. Further, it is also possible for the UL signal transmission unit 101 and the DL signal reception unit 102 to perform CA (including DC) between different RATs such as LTE and 5G.

The RRC management unit 103 includes a function for transmitting and receiving an RRC signal to and from the eNB, and performing processes of CA (DC) information setting/changing/managing, configuration change, etc. Further, the RRC management unit 103 includes a function for retaining capability information of the user apparatus UE and transmitting the capability information to the base station eNB as described in the modified example 3.

The UL transmission switching control unit 104 performs switching control between UL transmission CCs according to an embodiment (including modified examples). For example, it is possible for the UL transmission switching control unit 104 to retain or determine configuration information related to switching between CCs (length of a transient period, occurring timing of the transient period, and a cell as a transition reference), and controls the UL signal transmission unit 101 to perform switching between CCs according to the configuration information and the elapsed time. Further, it is possible for the UL transmission switching control unit 104 to operate according to the flow illustrated in FIG. 7, and control the UL signal transmission unit 101 to stop/perform UL transmission.

Further, the UL transmission switching control unit 104 includes a function for selecting a specific cell or a specific cell group as a reference of UL transmission carrier switching timing, from multiple cells or multiple cell groups with which CA is configured. Further, in the case where LTE-5G CA is performed, the UL transmission switching control unit 104 may include a function for retaining or determining a first transient period as a switching period from LTE cell carrier to 5G cell carrier and a second transient period as a switching period from 5G cell carrier to LTE cell carrier. Further, the UL transmission switching control unit 104 may be included in the UL signal transmission unit 101.

The structure of the user apparatus UE illustrated in FIG. 16 may be entirely realized by hardware circuit (e.g., one or more IC chips), or may be partially realized by hardware circuit and the remaining part may be realized by a CPU and programs.

FIG. 17 is a drawing illustrating an example of a hardware (HW) configuration of the user apparatus UE. FIG. 17 illustrates a structure closer to an implementation example compared to FIG. 16. As illustrated in FIG. 17, the UE includes a radio equipment (RE) module 151 for performing a process related to a wireless signal, a base band (BB) processing module 152 for performing a baseband signal process, an apparatus control module 153 for performing a process of an upper layer, etc., and a USIM slot 154 which is an interface for accessing a USIM card.

The RE module 151 generates a radio signal to be transmitted from an antenna by performing digital-to-analog (D/A) conversion, modulation, frequency conversion, power amplification, etc., for a digital baseband signal received from the BB processing module 152. Further, the RE module 151 generates digital baseband signal by performing frequency conversion, analog to digital (A/D) conversion, demodulation, etc., for a received radio signal, and transmits the generated signal to the BB processing module 152. The RE module 151 has, for example, a function of physical layer, etc., in the UL signal transmission unit 101 and the DL signal reception unit 102 illustrated in FIG. 16.

The BB processing module 152 performs a process of converting bi-directionally between an IP packet and a digital baseband signal. Digital signal processor (DSP) 162 is a processor for executing a signal processing in the BB processing module 152. A memory 172 is used as a work area of the DSP 162. The BB processing module 152 has, for example, a function of layer 2, etc., in the UL signal transmission unit 101 and the DL signal reception unit 102 illustrated in FIG. 16, and includes the RRC management unit 103 and the UL transmission switching control unit 104. It should be noted that all or a part of functions of the UL transmission switching control unit 104 may be included in the apparatus control module 153.

The apparatus control module 153 performs an IP layer protocol process, processes of various types of applications, etc. A processor 163 executes a process performed by the apparatus control module 153. A memory 173 is used as a work area of the processor 163. Further, the processor 163 reads/writes data from/to the USIM via the USIM slot 154.

FIG. 18 illustrates a functional configuration diagram of the eNB according to an embodiment. As illustrated in FIG. 18, the eNB includes a DL signal transmission unit 201, a UL signal reception unit 202, an RRC management unit 203, and a scheduling unit 204. FIG. 18 only illustrates functional units in the eNB especially related to an embodiment. The eNB further includes at least functions for performing operations according to LTE (not shown in the figure). Further, a functional structure illustrated in FIG. 18 is only an example. Functional classification and names of functional units may be anything as long as operations related to an embodiment can be performed. The eNB may be a single eNB, or may be a MeNB or a SeNB when DC is performed according to configurations.

The DL signal transmission unit 201 includes a function for wirelessly transmitting various kinds of physical layer signals generated from an upper layer signal which should be transmitted from the eNB. The UL signal reception unit 202 includes a function for wirelessly receiving various kinds of signals from the UEs, and obtaining upper layer signals from the received physical layer signals. Each of the DL signal transmission unit 201 and the UL signal reception unit 202 includes a function for performing CA (including DC) in which multiple CCs are bundled for communications. Further, the DL signal transmission unit 201 and the UL signal reception unit 202 may include a radio communication unit located remotely from the body (control unit) of the eNB similar to the RRE.

It is assumed, but not limited, that the DL signal transmission unit 201 and the UL signal reception unit 202 respectively have packet buffers and perform processes of layer 1 (PHY) and layer 2 (MAC, RLC, PDCP). Further, it is also possible for the DL signal transmission unit 201 and the UL signal reception unit 202 to perform CA (including DC) between different RATs such as LTE and 5G.

The RRC management unit 203 includes a function for transmitting and receiving an RRC message to and from the UE, and performing processes of CA (DC) setting/changing/managing, configuration change, etc. The RRC management unit 203 is a function unit for performing CA (DC) configuration, and may be referred to as a configuration unit. Further, the RRC control unit 203 may include a function for determining a specific cell/CG for the UE and transmitting the determined cell/CG to the UE via the DL signal transmission unit 201.

The scheduling unit 204 includes a function of performing scheduling for each cell for the user apparatus UE which performs CA (including DC), generating PDCCH allocation information, and causing the DL signal transmission unit 201 to transmit a PDCCH including the allocation information.

The structure of the base station eNB illustrated in FIG. 18 may be entirely realized by a hardware circuit (e.g., one or more IC chips), or may be partially realized by a hardware circuit and the remaining part may be realized by a CPU and programs.

FIG. 19 is a drawing illustrating an example of a hardware (HW) configuration of the base station eNB. FIG. 19 illustrates a structure closer to an implementation example compared to FIG. 18. As illustrated in FIG. 19, the base station eNB includes an RE module 251 for performing a process related to a wireless signal, a BB processing module 252 for performing a baseband signal process, an apparatus control module 253 for performing a process of an upper layer, etc., and a communication IF 254 as an interface for connecting to a network.

The RE module 251 generates a radio signal to be transmitted from an antenna by performing D/A conversion, modulation, frequency conversion, power amplification, etc., for a digital baseband signal received from the BB processing module 252. Further, the RE module 251 generates a digital baseband signal by performing frequency conversion, A/D conversion, demodulation, etc., for a received radio signal, and transmits the generated signal to the BB processing module 252. The RE module 251 has, for example, a function of physical layer, etc., in the DL signal transmission unit 201 and the UL signal reception unit 202 illustrated in FIG. 18.

The BB processing module 252 performs a process of converting bi-directionally between an IP packet and a digital baseband signal. DSP 262 is a processor for executing signal processing in the BB processing module 252. A memory 272 is used as a work area of the DSP 252. The BB processing module 252 has, for example, a function of layer 2, etc., in the DL signal transmission unit 201 and the UL signal reception unit 202 illustrated in FIG. 18, and includes the RRC management unit 203 and the scheduling unit 204. It should be noted that all or a part of functions of the RRC management unit 203 and the scheduling unit 204 may be included in the apparatus control module 253.

The apparatus control module 253 performs an IP layer protocol process, an OAM process, etc. A processor 263 executes a process performed by the apparatus control module 253. A memory 273 is used as a work area of the processor 263. An auxiliary storage apparatus 283 is, for example, a HDD, etc., and stores various types of setting information items, etc., used for operations of the base station eNB.

### Embodiment Summary

As described above, in an embodiment, a user apparatus which performs communications with one or more base stations in a communication system which supports carrier aggregation is provided. The user apparatus includes a control unit configured to select a specific cell or a specific cell group as a reference of a UL transmission carrier switching timing, from multiple cells or multiple cell groups with which the carrier aggregation is configured; and a transmission unit configured to perform switching from UL transmission using a first cell carrier to UL transmission using a second cell carrier based on a transient period timing in the selected specific cell or specific cell group. The above described UL transmission switching control unit 104 corresponds to the above control unit.

With the above arrangement, it is possible to provide a technique in which, in a mobile communication system which supports carrier aggregation, a user apparatus can appropriately perform UL transmission by time switching between carriers even in the case where multiple cells with which the carrier aggregation is configured are asynchronous.

The transmission unit may be configured not to perform UL transmission via a subframe which overlaps the transient period in the second cell in the case where the first cell is the selected specific cell or a cell included in the selected specific cell group. With the above arrangement, it is possible to avoid performing abnormal UL transmission, and thus, it is possible to contribute to reducing energy consumption and avoiding interference.

The control unit may select a PCell or a cell group including the PCell as the specific cell or the specific cell group. With the above arrangement, connectivity can be secured.

The control unit may select a specific cell or a specific cell group based on an index of each cell or each cell group in the multiple cells or the multiple cell groups. With the above arrangement, it is possible to select a specific cell or a specific cell group with a simple determination logic.

The control unit may select a specific cell or a specific cell group based on priority of a communication path set for each cell or each cell group in the multiple cells or the multiple cell groups. With the above arrangement, for example, it is possible to protect important communications.

The control unit may select a specific cell or a specific cell group based on a type of a channel or a type of a signal via which UL transmission is performed in each cell or each cell group in the multiple cells or the multiple cell groups. With the above arrangement, for example, it is possible to protect communications related to a specific channel or signal.

In the case where the carrier aggregation is configured with multiple cells including the first cell and the second cell which uses a TTI length different from a TTI length of the first cell, the control unit may retain a first transient period as a switching period from a first cell carrier to a second cell carrier and a second transient period as a switching period from the second cell carrier to the first cell carrier, and the transmission unit may use the first transient period when switching from the first cell carrier to the second cell carrier and use the second transient period when switching from the second cell carrier to the first cell carrier.

With the above arrangement, for example, in CA between different RATs such as LTE-5G CA, it is possible to appropriately perform time switching of UL transmission.

The control unit may select a specific cell or a specific cell group based on an instruction from the base station. With the above arrangement, it is possible to control flexibly according to the network side policy.

The transmission unit may transmit capability information related to UL transmission switching between carriers to the base station. With the above arrangement, it is possible for the base station to know the capability of UL transmission switching between carriers in the user apparatus, and it is possible for the base station to provide appropriate configuration when CA (DC) is configured for the user apparatus.

The user apparatus UE according to an embodiment may include a CPU and a memory, may be realized by having a program executed by the CPU (processor), may be realized by hardware such as hardware circuitry process in which the logic described in the first and second embodiments is included, or may be realized by a mixture of a program and hardware.

The base station eNB according to an embodiment may include a CPU and a memory, may be realized by having a program executed by the CPU (processor), may be realized by hardware such as hardware circuitry process in which the logic described in the first and second embodiments is included, or may be realized by a mixture of a program and hardware.

As described above, embodiments have been described. The disclosed invention is not limited to these embodiments, and a person skilled in the art would understand various variations, modifications, replacements, or the like. Specific examples of numerical values have been used for encouraging understanding of the present invention. These numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. For the sake of description convenience, the user apparatus and the base station have been described using functional block diagrams. These apparatuses may be implemented by hardware, by software, or by combination of both. The software which is executed by a processor included in a user apparatus according to an embodiment and the software which is executed by a processor included in a base station may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium. The present invention is not limited to the above embodiments and various variations, modifications, alternatives, replacements, etc., may be included in the present invention without departing from the spirit of the invention.

The present application is based on and claims the benefit of priority of Japanese Priority Application No. 2015-032343 filed on Feb. 20, 2015, the entire contents of which are hereby incorporated by reference.

### DESCRIPTION OF THE REFERENCE NUMERALS

UE user apparatus
eNB, MeNB, SeNB base station
101 UL signal transmission unit
102 DL signal reception unit
103 RRC management unit
104 UL transmission switching control unit
151 RE module
152 BB processing module
153 Apparatus control module
154 USIM slot
201 DL signal transmission unit
202 UL signal reception unit
203 RRC management unit
204 scheduling unit
251 RE module
252 BB processing module
253 Apparatus control module
254 Communication IF

1. A user apparatus performing communications with one or more base stations in a mobile communication system which supports carrier aggregation, the user apparatus comprising:
a control unit configured to select a specific cell or a specific cell group as a reference of an uplink transmission carrier switching timing, from a plurality of cells or a plurality of cell groups with which the carrier aggregation is configured; and
a transmission unit configured to perform switching from uplink transmission using a first cell carrier to uplink transmission using a second cell carrier based on a timing of a transient period in the selected specific cell or the selected specific cell group.

2. The user apparatus according to claim 1, wherein
the transmission unit does not perform uplink transmission via a subframe which overlaps the transient period in the second cell in the case where the first cell is the selected specific cell or included in the selected specific cell group.

3. The user apparatus according to claim 1, wherein
the control unit selects a PCell or a cell group including the PCell as the specific cell or the specific cell group.

4. The user apparatus according to claim 1, wherein
the control unit selects the specific cell or the specific cell group based on indices of the cells or the cell groups.

5. The user apparatus according to claim 1, wherein
the control unit selects the specific cell or the specific cell group based on priority of a communication path set for each cell or each cell group in the cells or the cell groups.

6. The user apparatus according to claim 1, wherein
the control unit selects the specific cell or the specific cell group based on a type of a channel or a type of a signal via which uplink transmission is performed in each of the cells or each of the cell groups.

7. The user apparatus according to claim 1, wherein
in the case where the carrier aggregation is configured with multiple cells including the first cell and the second cell using a TTI length different from that of the first cell,
the control unit retains a first transient period as a switching period from the first cell carrier to the second cell carrier and a second transient period as a switching period from the second cell carrier to the first cell carrier, and
the transmission unit uses the first transient period when switching from the first cell carrier to the second cell carrier and uses the second transient period when switching from the second cell carrier to the first cell carrier.

8. The user apparatus according to claim 1, wherein
the control unit selects the specific cell or the specific cell group based on an instruction from the base station.

9. The user apparatus according to claim 1, wherein
the transmission unit transmits capability information related to uplink transmission switching between carriers to the base station.

10. An uplink transmission switching method performed by a user apparatus performing communication with one or more base stations in a mobile communication system which supports carrier aggregation, the uplink transmission switching method comprising:
a step of selecting a specific cell or a specific cell group as a reference of an uplink transmission carrier switching timing, from a plurality of cells or a plurality of cell groups with which the carrier aggregation is configured; and
a step of performing switching from uplink transmission using a first cell carrier to uplink transmission using a second cell carrier based on a timing of a transient period in the selected specific cell or the selected specific cell group.

11. The user apparatus according to claim 2, wherein
the control unit selects a PCell or a cell group including the PCell as the specific cell or the specific cell group.

12. The user apparatus according to claim 2, wherein
the control unit selects the specific cell or the specific cell group based on indices of the cells or the cell groups.

13. The user apparatus according to claim 2, wherein
the control unit selects the specific cell or the specific cell group based on priority of a communication path set for each cell or each cell group in the cells or the cell groups.

14. The user apparatus according to claim 2, wherein
the control unit selects the specific cell or the specific cell group based on a type of a channel or a type of a signal via which uplink transmission is performed in each of the cells or each of the cell groups.

15. The user apparatus according to claim 2, wherein
in the case where the carrier aggregation is configured with multiple cells including the first cell and the second cell using a TTI length different from that of the first cell,
the control unit retains a first transient period as a switching period from the first cell carrier to the second cell carrier and a second transient period as a switching period from the second cell carrier to the first cell carrier, and
the transmission unit uses the first transient period when switching from the first cell carrier to the second cell carrier and uses the second transient period when switching from the second cell carrier to the first cell carrier.

16. The user apparatus according to claim 2, wherein
the control unit selects the specific cell or the specific cell group based on an instruction from the base station.

17. The user apparatus according to claim 2, wherein
the transmission unit transmits capability information related to uplink transmission switching between carriers to the base station.

18. The user apparatus according to claim 3, wherein
the control unit selects the specific cell or the specific cell group based on indices of the cells or the cell groups.

19. The user apparatus according to claim 3, wherein
the control unit selects the specific cell or the specific cell group based on priority of a communication path set for each cell or each cell group in the cells or the cell groups.

20. The user apparatus according to claim 3, wherein
the control unit selects the specific cell or the specific cell group based on a type of a channel or a type of a signal via which uplink transmission is performed in each of the cells or each of the cell groups.
